(19) United States
(12) Patent Application Publication
(10) Pub. No.: US 2024/0250445 A1
(43) Pub. Date: Jul. 25, 2024

(54) ANTENNA DEVICE AND WIRELESS DEVICE

(71) Applicant: KABUSHIKI KAISHA TOSHIBA, Tokyo (JP)

(72) Inventor: Makoto SANO, Ota Tokyo (JP)

(73) Assignee: KABUSHIKI KAISHA TOSHIBA, Tokyo (JP)

(21) Appl. No.: 18/447,371

(22) Filed: Aug. 10, 2023

(30) Foreign Application Priority Data
Jan. 24, 2023 (JP) 2023-008851

(51) Int. Cl. H01Q 13/26; H01Q 3/04; H01Q 3/14

(52) U.S. Cl. CPC H01Q 13/26; H01Q 3/04; H01Q 3/14

(57) ABSTRACT

According to one embodiment, an antenna device includes a waveguide. The waveguide includes a feed point, and a first region around the feed point. The waveguide is configured to guide a high-frequency signal supplied to the feed point. The waveguide includes a plurality of radiating parts located in the first region. The first region includes a first partial region and a second partial region. The feed point is between the first partial region and the second partial region. A first waveguide wavelength in the waveguide in the first partial region is less than a second waveguide wavelength in the waveguide in the second partial region.

### CROSS-REFERENCE TO RELATED APPLICATIONS

This application is based upon and claims the benefit of priority from Japanese Patent Application No. 2023-008851, filed on Jan. 24, 2023; the entire contents of which are incorporated herein by reference.

### FIELD

Embodiments described herein relate generally to an antenna device and a wireless device.

### BACKGROUND

For example, it is desirable to improve the characteristics of an antenna device and a wireless device.

### BRIEF DESCRIPTION OF THE DRAWINGS

FIGS. 1A and 1B are schematic views illustrating an antenna device according to a first embodiment;

FIG. 2A is a plan view, and FIG. 2B is a perspective view;

FIGS. 3A to 3C are schematic cross-sectional views illustrating the antenna device according to the first embodiment;

FIGS. 4A to 4C are schematic views illustrating portions of the antenna device according to the first embodiment;

FIGS. 5A to 5C are schematic views illustrating portions of the antenna device according to the first embodiment;

FIGS. 6A and 6B are schematic views illustrating portions of the antenna device according to the first embodiment;

FIG. 7 is a schematic view illustrating a portion of the antenna device according to the first embodiment;

FIG. 8 is a graph illustrating characteristics of the antenna device;

FIG. 9 is a graph illustrating a characteristic of the antenna device according to the embodiment;

FIGS. 10A and 10B are schematic cross-sectional views illustrating an antenna device according to the first embodiment;

FIG. 11 is a schematic cross-sectional view illustrating an antenna device according to a second embodiment;

FIG. 12 is a schematic perspective view illustrating an antenna device according to a third embodiment;

FIG. 13 is a schematic perspective view illustrating an antenna device according to the third embodiment;

FIG. 14 is a schematic view illustrating a portion of the antenna device according to the third embodiment;

FIG. 15 is a schematic view illustrating a portion of the antenna device according to the third embodiment;

FIG. 16 is a schematic view illustrating a portion of the antenna device according to the third embodiment;

FIG. 17 is a schematic view illustrating the antenna device according to the third embodiment;

FIG. 18 is a schematic view illustrating the antenna device according to the third embodiment;

FIG. 19 is a schematic view illustrating the antenna device according to the third embodiment;

FIGS. 20A and 20B are schematic views illustrating characteristics of the antenna device according to the third embodiment;

FIG. 21 is a schematic view illustrating an antenna device according to the third embodiment; and

FIG. 22 is a schematic view illustrating the wireless device according to a fourth embodiment.

### DETAILED DESCRIPTION

According to one embodiment, an antenna device includes a waveguide. The waveguide includes a feed point, and a first region around the feed point. The waveguide is configured to guide a high-frequency signal supplied to the feed point. The waveguide includes a plurality of radiating parts located in the first region. The first region includes a first partial region and a second partial region. The feed point is between the first partial region and the second partial region. A first waveguide wavelength in the waveguide in the first partial region is less than a second waveguide wavelength in the waveguide in the second partial region.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

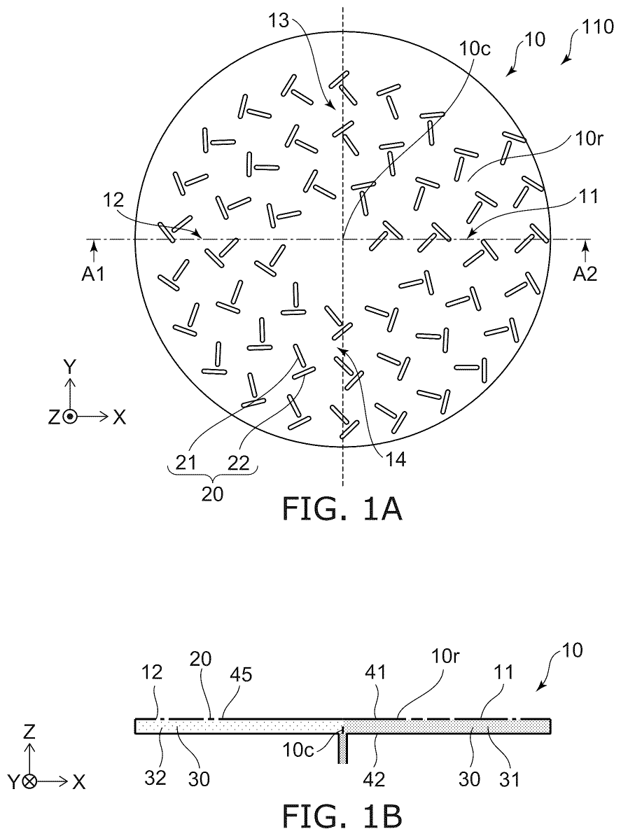

FIGS. 1A and 1B are schematic views illustrating an antenna device according to a first embodiment.

FIG. 1B is a cross-sectional view corresponding to line A1-A2 of FIG. 1A.

As shown in FIGS. 1A and 1B, the antenna device 110 according to the embodiment includes a waveguide 10. The waveguide 10 includes a feed point 10c and a first region 10r. The first region 10r is around the feed point 10c.

As shown in FIG. 1A, the waveguide 10 may be substantially a circle centered on the feed point 10c. The planar shape of the waveguide 10 is arbitrary. For example, the first region 10r has an annular shape located around the feed point 10c.

A direction perpendicular to the first region 10r is taken as a Z-axis direction. One direction perpendicular to the Z-axis direction is taken as an X-axis direction. A direction perpendicular to the Z-axis direction and the X-axis direction is taken as a Y-axis direction. The first region 10r spreads along the X-Y plane.

The waveguide 10 is configured to guide a high-frequency signal supplied to the feed point 10c. The waveguide 10 is, for example, a transmission line configured to propagate the high-frequency signal. The waveguide 10 may be, for example, a radial waveguide. The waveguide 10 may be, for example, a dielectric waveguide. The waveguide 10 may be, for example, a waveguide tube. The high-frequency signal that is supplied to the feed point 10c propagates through the waveguide 10. The propagation direction is a radial direction passing through the feed point 10c.

As shown in FIG. 1B, the waveguide 10 may include a first conductive layer 41 and a second conductive layer 42. The direction from the second conductive layer 42 toward the first conductive layer 41 is along the Z-axis direction.

The waveguide 10 may include multiple radiating parts 20. The multiple radiating parts 20 are located in the first region 10r.

In one example, one of the multiple radiating parts 20 (e.g., each of the multiple radiating parts 20) may include a slot pair. The slot pair includes, for example, a first slot 21 and a second slot 22. These slots correspond to apertures 45 provided in the first conductive layer 41 (see FIG. 1B). In the example, the direction in which the first slot 21 extends crosses the direction in which the second slot 22 extends. Various modifications of the configuration of the multiple radiating parts 20 are possible. For example, the shape of the first slot 21 may be different from the shape of the second slot 22. The direction in which the first slot 21 extends may not cross the direction in which the second slot 22 extends. The direction in which the first slot 21 extends may be substantially parallel to the direction in which the second slot 22 extends. The multiple radiating parts 20 function as multiple radiating elements. As described below, an electromagnetic wave that corresponds to the high-frequency signal propagating through the waveguide 10 is radiated from the multiple radiating parts 20.

As shown in FIG. 1A, the first region 10r includes a first partial region 11 and a second partial region 12. The feed point 10c is between the first partial region 11 and the second partial region 12. A first waveguide wavelength λ1 in the waveguide in the first partial region 11 is less than a second waveguide wavelength 12 in the waveguide in the second partial region 12.

Thus, according to the embodiment, the waveguide wavelengths (e.g., the guide wavelengths) are different in the plane of the first region 10r. Accordingly, the radiation direction of the electromagnetic wave radiated from the multiple radiating parts 20 can be tilted with respect to the Z-axis direction.

For example, in a first reference example in which the radiation direction of the electromagnetic wave is tilted with respect to the Z-axis direction, the spacing (the density) of the multiple radiating parts 20 is changed in the plane. In the first reference example, the spacing in the radial direction between the multiple radiating elements corresponding to the tilt direction is increased. On the other hand, the spacing in the radial direction between the multiple radiating elements in the direction opposite to the tilt direction are reduced. Increasing the spacing in the tilt direction causes unnecessary grating lobes. Furthermore, the range of sizes of the multiple radiating elements becomes narrow when the spacing in the direction opposite to the tilt direction is reduced. For example, design freedom is reduced.

In the first reference example, a method of increasing the dielectric constant of the dielectric waveguide may be considered to prevent grating lobes. The element spacing in the tilt direction may be reduced thereby. However, as the dielectric constant increases, the loss due to the dielectric increases, and the efficiency decreases. Also, as the dielectric constant increases, the element spacing in the direction opposite to the tilt direction is further reduced, and the design freedom is further reduced.

In contrast, according to the embodiment, the first waveguide wavelength λ1 is less than the second waveguide wavelength λ2. Thus, the waveguide wavelengths (e.g., the guide wavelengths) are different in the plane of the first region 10r. Accordingly, the radiation direction of the electromagnetic wave radiated from the multiple radiating parts 20 can be tilted with respect to the Z-axis direction without changing the spacing of the multiple radiating parts 20. For example, the grating lobes are suppressed thereby. For example, a high efficiency can be maintained. For example, high design freedom can be maintained. The performance of the antenna can be improved by high design freedom. According to the embodiment, an antenna device can be provided in which the characteristics can be improved.

As shown in FIG. 1B, the waveguide 10 may include a first member 30. The first member 30 is located between the first conductive layer 41 and the second conductive layer 42. The waveguide wavelength (e.g., the guide wavelength) can be controlled by appropriately controlling the configuration of the first member 30. Examples of the first member 30 are described below.

As shown in FIG. 1A, the first region 10r may include a third partial region 13 and a fourth partial region 14. The feed point 10c is between the third partial region 13 and the fourth partial region 14. The direction from the feed point 10c toward the third partial region 13 crosses the direction from the feed point 10c toward the first partial region 11. The direction from the feed point 10c toward the fourth partial region 14 crosses the direction from the feed point 10c toward the first partial region 11. The angle between the direction from the feed point 10c toward the third partial region 13 and the direction from the feed point 10c toward the first partial region 11 may be substantially 90 degrees. The angle between the direction from the feed point 10c toward the fourth partial region 14 and the direction from the feed point 10c toward the first partial region 11 may be substantially 90 degrees.

For example, a third waveguide wavelength 23 in the waveguide in the third partial region 13 is greater than the first waveguide wavelength λ1 and less than the second waveguide wavelength 22. A fourth waveguide wavelength 24 in the waveguide in the fourth partial region 14 is greater than the first waveguide wavelength λ1 and less than the second waveguide wavelength 22.

For example, high design freedom can be maintained in the third and fourth partial regions 13 and 14. The performance of the antenna can be improved.

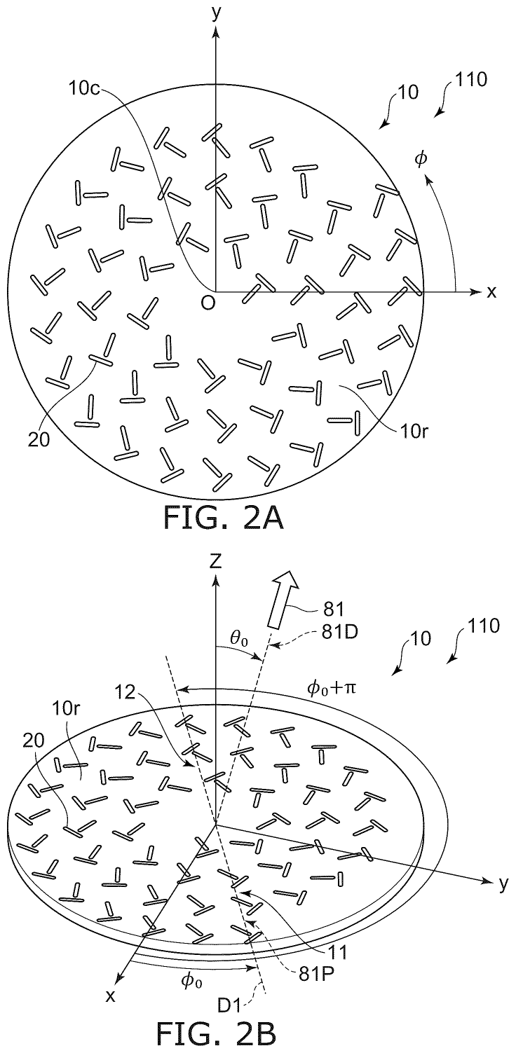

FIGS. 2A and 2B are schematic views illustrating the antenna device according to the first embodiment.

FIG. 2A is a plan view. FIG. 2B is a perspective view.

As shown in FIGS. 2A and 2B, an x-axis and a y-axis can be set. An origin O of these axes corresponds to the feed point 10c. As shown in FIG. 2B, the x-axis and the y-axis are along the first region 10r. The y-axis is perpendicular to the x-axis. The x-axis is one reference axis. The angle between the x-axis and the direction from the feed point 10c toward the first partial region 11 is taken as an angle do. The angle do corresponds to the angle in the circumferential direction of the direction from the feed point 10c toward the first partial region 11 referenced to the x-axis. The angle between the x-axis and the direction from the feed point 10c toward the second partial region 12 corresponds to the angle (ϕ₀+180°).

For example, the first waveguide wavelength λ1 corresponds to the guide wavelength in the direction of the angle do in the circumferential direction in the waveguide 10 when viewed from the feed point 10c. The second waveguide wavelength 12 corresponds to the guide wavelength in the direction of the angle (ϕ₀+180°) in the waveguide 10 when viewed from the feed point 10c.

For example, the third waveguide wavelength 13 corresponds to the guide wavelength in the direction of the angle (ϕ₀+90°) in the circumferential direction in the waveguide 10 when viewed from the feed point 10c. The fourth waveguide wavelength λ4 corresponds to the guide wavelength in the direction of the angle (ϕ₀−90°) in the circumferential direction in the waveguide 10 when viewed from the feed point 10c.

For example, the first waveguide wavelength λ1 is the wavelength (the guide wavelength) of the high-frequency signal propagating along the direction from the feed point 10c toward the first partial region 11. The second waveguide wavelength λ2 is the wavelength (the guide wavelength) of the high-frequency signal propagating along the direction from the feed point 10c toward the second partial region 12.

As shown in FIG. 1B, the multiple radiating parts 20 are configured to radiate a first electromagnetic wave 81. The first electromagnetic wave 81 corresponds to the high-frequency signal propagating through the waveguide 10. A major radiation direction 81D of the first electromagnetic wave 81 is tilted with respect to the Z-axis direction. The Z-axis direction is a direction perpendicular to the first region 10r. An angle θ₀ (the tilt angle) between the major radiation direction 81D and the Z-axis direction is greater than 0. A projection direction 81P of the major radiation direction 81D onto the waveguide 10 is along a first direction D1 from the second partial region 12 toward the first partial region 11.

For example, in the antenna device 110, the first electromagnetic wave 81 is radiated with beam tilt. For example, an extremely narrow spacing of the multiple radiating parts 20 in the direction (the second partial region 12) opposite to the tilt direction can be suppressed. Design freedom of the size, position, etc., of the multiple radiating parts 20 is increased. The performance of the antenna can be improved.

Examples of the waveguide 10 will now be described.

For example, the high-frequency signal may be input to the feed point 10c of the waveguide 10 via a coaxial line. For example, the high-frequency signal may be input to the feed point 10c via a waveguide tube.

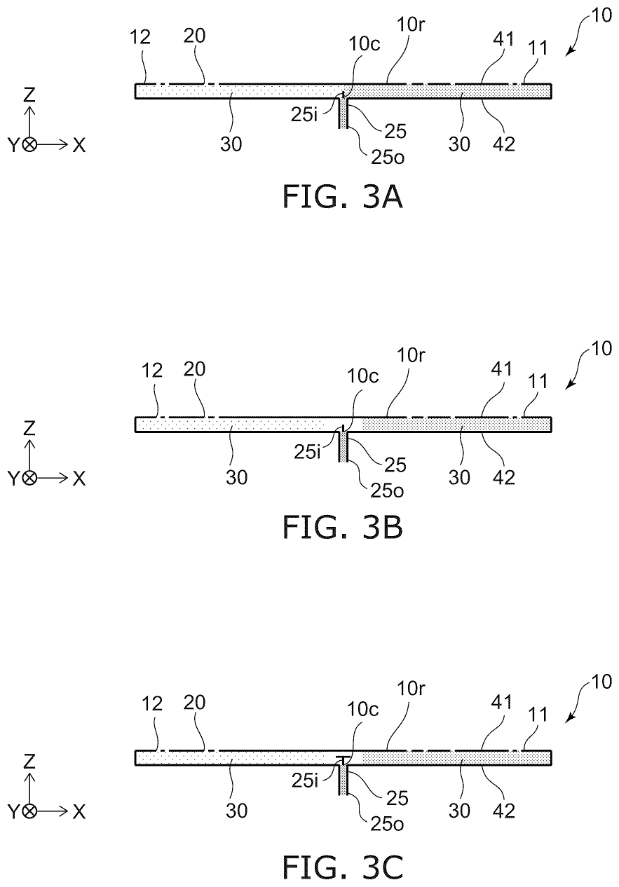

FIGS. 3A to 3C are schematic cross-sectional views illustrating the antenna device according to the first embodiment.

These drawings show several examples of the feed point 10c. In these drawings, the high-frequency signal is input to the waveguide 10 (e.g., a radial waveguide) via a coaxial line 25.

As shown in FIG. 2A, an outer conductor 250 of the coaxial line 25 is electrically connected to the second conductive layer 42 (the ground plate) of the waveguide 10 (the radial waveguide). An inner conductor 25i of the coaxial line 25 is inserted into the waveguide 10. For example, impedance matching is obtained by changing the insertion length of the inner conductor 25i. A hole having about the same diameter as the inner conductor 25i may be provided in the first member 30 to insert the inner conductor 25i.

In the example of FIG. 2B, the first member 30 may not be provided locally at the periphery of the inner conductor 25i. For example, impedance matching is obtained by controlling the length (the size) of the region at which the first member 30 is not provided.

In the example of FIG. 2C, the shape of the end portion of the inner conductor 25i may be modified. The impedance matching is obtained thereby.

The multiple radiating parts 20 radiate the high-frequency signal propagating through the waveguide 10 to the space outside the waveguide 10. The multiple radiating parts 20 are radiating elements (antennas). The multiple radiating parts 20 are provided in the first region 10r around the feed point 10c. The multiple radiating parts 20 function as an array antenna.

One of the multiple radiating parts 20 may be a slot pair. One of the multiple radiating parts 20 may be a single slot antenna. One of the multiple radiating parts 20 may be a helical antenna. One of the multiple radiating parts 20 may be a patch antenna. One of the multiple radiating parts 20 may be a dipole antenna. One of the multiple radiating parts 20 may be a dielectric resonator antenna. One of the multiple radiating parts 20 may be a leaky-wave antenna. Various configurations are applicable to the multiple radiating parts 20.

The multiple radiating parts 20 may be arranged in a substantially spiral configuration in the first region 10r. The center of the spiral is the feed point 10c. The multiple radiating parts 20 may be arranged in a substantially concentric circular configuration in the first region 10r. The center of the concentric circles is the feed point 10c.

As described above, the waveguide 10 may include the first member 30. For example, the first member 30 corresponds to a slow-wave structure. The waveguide wavelength (e.g., the guide wavelength) can be changed in the plane of the first region 10r by the first member 30. The first member 30 has the function of adjusting the guide wavelength of the high-frequency signal propagating through the waveguide 10.

For example, a first slow-wave ratio of the first member 30 in the first partial region 11 is different from the second slow-wave ratio of the first member 30 in the second partial region 12. In one example, the first member 30 includes a dielectric. In one example, the slow-wave ratio can be controlled by changing the dielectric constant (e.g., the effective dielectric constant) of the first member 30.

For example, it is easier to control the guide wavelength by changing the slow-wave ratio of the first member 30. For example, the control range of the guide wavelength is increased. For example, the change of the guide wavelength due to a frequency change can be reduced. For example, a narrow operating band of the antenna can be suppressed.

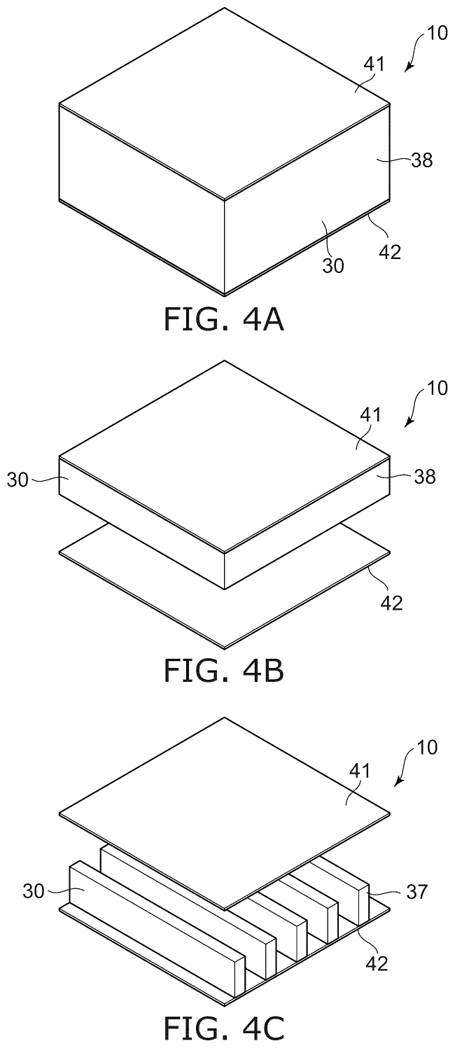

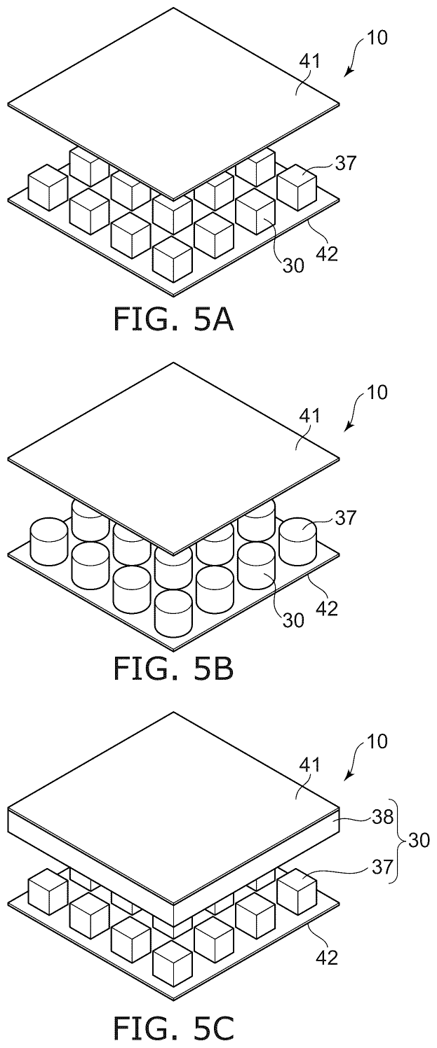

FIGS. 4A to 4C and FIGS. 5A to 5C are schematic views illustrating portions of the antenna device according to the first embodiment.

As shown in FIG. 4A, the first member 30 may include a dielectric 38. The guide wavelength in the waveguide 10 changes according to the relative dielectric constant of the dielectric 38. The relative dielectric constant is taken as εᵣ. The free-space wavelength is taken as λ₀. Then, a guide wavelength λg in the waveguide 10 is represented by λ_{g}=λ₀/(εᵣ)^{1/2}.

When the waveguide 10 is a waveguide tube, the guide wavelength also changes according to the tube width of the waveguide tube. The guide wavelength may be adjusted by changing the tube width in addition to the relative dielectric constant. The first member 30 is considered to be a slow-wave structure even when the relative dielectric constant of the dielectric 38 is substantially 1.

In FIG. 4B, the dielectric 38 is located at a portion inside the waveguide 10. When the dielectric 38 is partially filled, the guide wavelength can be controlled by controlling the fill factor.

In FIG. 4C, the first member 30 (the slow-wave structure) includes a structure body 37. In the example, the structure body 37 is a corrugation. In one example, the structure body 37 is, for example, conductive. The material of the structure body 37 may be the same as or different from the material of the second conductive layer 42. The guide wavelength can be shortened by making the corrugation deep. Other than the depth of the corrugation, the reflections can be reduced by changing the spacing of the corrugation.

In FIG. 5A, a columnar first member 30 is provided in the waveguide 10. For example, the first member 30 includes multiple rectangular parallelepiped structure bodies 37 (pillars). The guide wavelength is changed by changing the size and spacing of the multiple structure bodies 37.

As shown in FIG. 5B, the structure body 37 may be cylindrical. The structure body 37 may have various shapes such as polygonal prismatic, polygonal-pyramid, etc.

As shown in FIG. 5C, the dielectric 38 and the structure body 37 may be provided in combination. The first member 30 includes the dielectric 38 and the structure body 37. The structure body 37 may be a pillar or a corrugation.

The effective relative dielectric constant may be changed by changing the density of the dielectric 38. For example, one type of dielectric 38 can be included to control the distribution of the relative dielectric constant by changing the density of the dielectric 38.

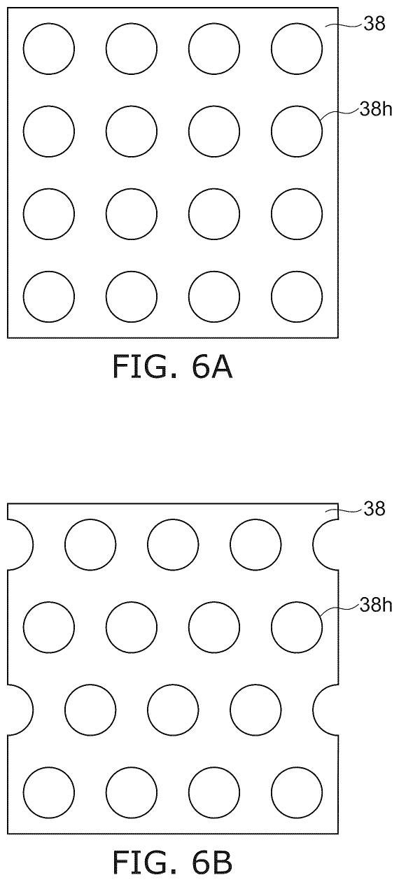

FIGS. 6A and 6B are schematic views illustrating portions of the antenna device according to the first embodiment.

As shown in FIGS. 6A and 6B, the dielectric 38 may include multiple holes 38h. In the example of FIG. 6A, the multiple holes 38h are located at the lattice points of a rectangular lattice. In the example of FIG. 6B, the multiple holes 38h may be provided at the lattice points of a hexagonal lattice. The anisotropy of the relative dielectric constant can be reduced by providing the multiple holes 38h at the lattice points of a hexagonal lattice.

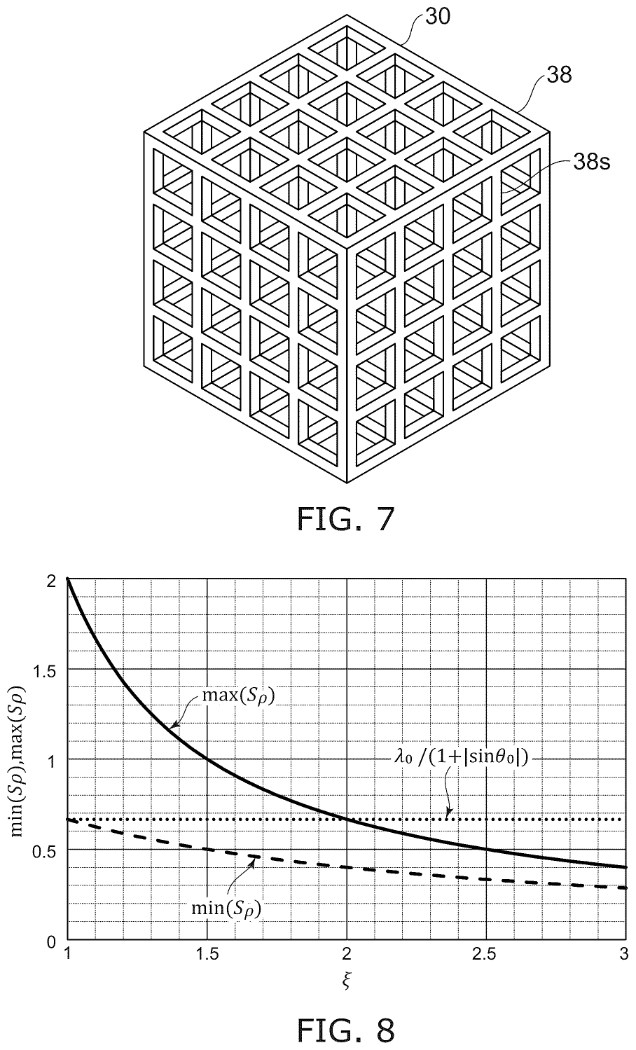

FIG. 7 is a schematic view illustrating a portion of the antenna device according to the first embodiment.

As shown in FIG. 7, the dielectric 38 that is included in the first member 30 may have a three-dimensional lattice shape. The adjustment range of the effective relative dielectric constant is increased by three-dimensionally changing the shape of the dielectric 38. For example, the anisotropy can be reduced. For example, the mechanical strength is increased. Various methods are applicable to make the shape of the dielectric 38 such as, for example, hole formation, resin injection molding, formation with a 3D printer, etc.

For example, the first member 30 includes a first member region 31 and a second member region 32 (see FIG. 1B). The first member region 31 corresponds to the first partial region 11. The second member region 32 corresponds to the second partial region 12.

For example, the first member region 31 and the second member region 32 may satisfy at least one of a first condition, a second condition, a third condition, or a fourth condition. In the first condition, the relative dielectric constant of the first member region 31 is different from the relative dielectric constant of the second member region 32. In the second condition, the density of the multiple holes 38h included in the first member region 31 is different from the density of the multiple holes 38h included in the second member region 32. In the third condition, the average size of the multiple holes 38h included in the first member region 31 is different from the average size of the multiple holes 38h included in the second member region 32. In the fourth condition, the configuration of the structure body 37 provided in the first member region 31 is different from the configuration of the structure body 37 provided in the second member region 32.

For example, by providing the first member 30 including the dielectric 38, the control of the guide wavelength is easier, and the control range of the guide wavelength is increased.

As shown in FIG. 2A, the spacing in the radial direction of the multiple radiating parts 20 when viewed from the center of the waveguide 10 is taken as a spacing Sp. The spacing in the circumferential direction of the multiple radiating parts 20 is taken as a spacing S_{ϕ}. The spacing Sp is the distance along the radial direction between the radial-direction center of one of the multiple radiating parts 20 and the radial-direction center of an adjacent one of the multiple radiating parts 20. The spacing S_{ϕ} is the distance along the circumferential direction between the circumferential-direction center of one of the multiple radiating parts 20 and the circumferential-direction center of an adjacent one of the multiple radiating parts 20.

The major radiation direction 81D of the first electromagnetic wave 81 radiated from the multiple radiating parts 20 is taken as (θ, ϕ)=(θ₀, ϕ₀). When the spacing S_{ϕ} is small enough that grating lobes substantially do not occur, the spacing S_{ϕ} can be set relatively freely to values regardless of the major radiation direction 81D.

On the other hand, the spacing S_{ρ} is set to an appropriate value. A phase distribution in the aperture plane necessary for the beam tilt is formed thereby. According to the embodiment, the spacing S_{ρ} may be determined by the following first formula.

$${S}_{ρ} ( ϕ ) = \frac{{λ}_{0} / ξ}{1 - ( 1 / ξ ) sin {θ}_{0} cos ( ϕ - {ϕ}_{0} )} \qquad ( 1 )$$

In the first formula, “λ₀” is the free-space wavelength. “ξ” is the slow-wave ratio. The slow-wave ratio is the ratio of the guide wavelength λ_{g} in the radial waveguide to the free-space wavelength λ₀. That is, ξ=λ₀/λ_{g}.

For example, the slow-wave structure of the first member 30 is formed using the dielectric 38 having the relative dielectric constant εr. In such a case, ξ=(εᵣ)^{1/2}.

When the slow-wave ratio ξ in the radial waveguide is uniform in the waveguide 10, S_{ρ} changes according to the angle ϕ. The spacing S_{ρ} of the multiple radiating parts 20 is a minimum when ϕ=ϕ₀+180º. The minimum value min(Sr) of the spacing S_{ρ} is represented by the following second formula.

$$min ( {S}_{ρ} ) = \frac{{λ}_{0} / ξ}{1 + ( 1 / ξ ) sin {θ}_{0}} \qquad ( 2 )$$

On the other hand, the spacing Sp of the multiple radiating parts 20 is a maximum when ϕ=ϕ₀. The maximum value max(S_{ρ}) of the spacing Sp is represented by the following third formula.

$$max ( {S}_{ρ} ) = \frac{{λ}_{0} / ξ}{1 - ( 1 / ξ ) sin {θ}_{0}} \qquad ( 3 )$$

FIG. 8 is a graph illustrating characteristics of the antenna device.

FIG. 8 shows examples of the minimum value min(S_{ρ}) and the maximum value max(S_{ρ}). The horizontal axis of FIG. 8 is the slow-wave ratio ξ. The vertical axis is the minimum value min(S_{ρ}) or the maximum value max(S_{ρ}). FIG. 8 corresponds to a reference example in which the slow-wave ratio ξ is modified.

As shown in FIG. 8, the minimum value min(S_{ρ}) and the maximum value max(S_{ρ}) decrease as the slow-wave ratio ξ increases. The maximum value max(S_{ρ}) is less than λ₀/(1+|sin θ₀|) when the slow-wave ratio ξ is greater than 2. In such a case, grating lobes substantially no longer occur.

On the other hand, the minimum value min(S_{ρ}) is less than 0.4Δ₀ when the slow-wave ratio ξ is greater than 2. For example, when the multiple radiating parts 20 include slot pairs, the slots have a maximum length of about 0.5λ₀. Also, the slot pair spacing is set to about λ_{g}/4 to suppress reflections. It is therefore difficult to arrange the slot pairs in regions of narrow element spacing. Short slots that have weak radiation amounts are used to arrange the slot pairs. For example, the design freedom degrades when the slot pair spacing is reduced by sacrificing reflection. Also, the performance of the antenna degrades.

When the slow-wave ratio ξ in the radial waveguide is constant, the spacing S_{ρ} fluctuates according to the angle ϕ as described above. When the slow-wave ratio ξ is increased to set the maximum value max(S_{ρ}) to be less than λ₀/(1+|sin θ₀|) so that grating lobes no longer occur, the spacing S_{ρ} becomes narrow, and regions occur where it is difficult to arrange the slot pairs.

In contrast, according to the embodiment, the slow-wave ratio ξ in the radial waveguide is appropriately controlled according to the angle ϕ. Thereby, the spacing S_{ρ} can be in the desired range (e.g., constant) regardless of the angle ϕ.

For example, the following fourth formula can be derived from the first formula.

$$ξ ( ϕ ) = \frac{{λ}_{0}}{{S}_{ρ}} + sin {θ}_{0} cos ( ϕ - {ϕ}_{0} ) \qquad ( 4 )$$

For example, by changing the slow-wave ratio ξ in the radial waveguide according to the fourth formula, the spacing S_{ρ} can be constant regardless of the angle ϕ.

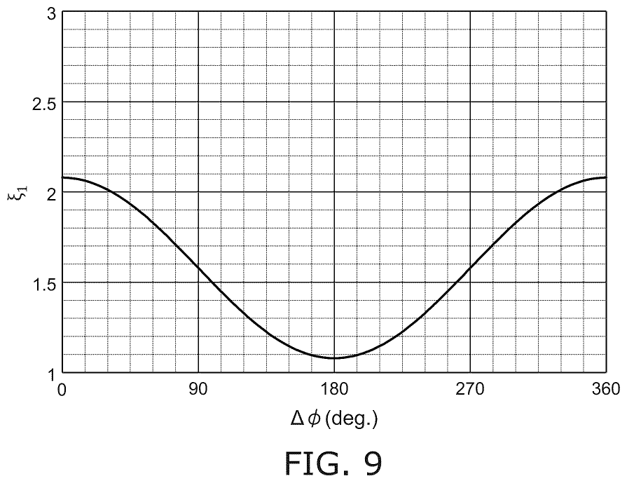

FIG. 9 is a graph illustrating a characteristic of the antenna device according to the embodiment.

FIG. 9 illustrates the distribution of the slow-wave ratio ξ in one example. The horizontal axis of FIG. 9 is an angular difference Δϕ. The angular difference Δϕ is ϕ−ϕ₀. The vertical axis is a slow-wave ratio ξ₁. The slow-wave ratio ξ₁ is the slow-wave ratio ξ at which the spacing S_{ρ} of the multiple radiating parts 20 becomes substantially 0.95λ₀/(1+|sin θ₀|) regardless of the angle ϕ. “0.95λ₀/(1+|sin θ₀|)” is substantially 0.63λ₀. In the example of FIG. 9, the angle θ₀ is 30°.

As shown in FIG. 9, the spacing S_{ρ} of the multiple radiating parts 20 is substantially 0.95λ₀/(1+|sin θ₀|) regardless of the angle ϕ by increasing the slow-wave ratio ξ when the angular difference Δϕ is 0 degrees and by reducing the slow-wave ratio ξ when the angular difference Δϕ is 180 degrees. An angular difference Δϕ of 0 degrees corresponds to the beam tilt direction. An angular difference Δϕ of 180 degrees corresponds to the direction opposite to the beam tilt direction. The spacing S_{ρ} of the multiple radiating parts 20 can be made constant by such a slow-wave ratio ξ distribution.

According to the embodiment as described above, an extremely short spacing S_{ρ} can be suppressed by appropriately changing the slow-wave ratio ξ distribution according to the angle ϕ. For example, the regions in which the multiple radiating parts 20 (e.g., the slot pairs) can be located increase. The design freedom can be improved. The performance of the antenna device 110 can be improved.

For example, according to the embodiment, the first member 30 that includes the dielectric 38 can be used to easily reduce the relative dielectric constant in regions where the slow-wave ratio ξ is low. For example, the dielectric loss can be reduced.

According to the embodiment, it is desirable for the spacing S_{ρ} of the multiple radiating parts 20 in the radial direction passing through the feed point 10c along the first region 10r to be less than λ₀/(1+sin θ₀). “λ₀” is the wavelength of the high-frequency signal in free space. “θ₀” is the angle between a direction (the Z-axis direction) perpendicular to the first region 10r and the major radiation direction 81D of the first electromagnetic wave 81 radiated from the multiple radiating parts 20 (see FIG. 2B). The grating lobes can be effectively suppressed thereby.

As described above, one of the multiple radiating parts 20 may include a slot pair. For example, the reflections from the two slots are canceled thereby. The reflections of the multiple radiating parts 20 can be reduced thereby. For example, the performance of the antenna can be improved by adjusting the slot length, slot width, slot position, distance between two slots, etc.

According to the embodiment, the multiple radiating parts 20 may be capable of radiating a circularly polarized wave. By radiating a circularly polarized wave, for example, wireless communication or the like using the first electromagnetic wave 81 radiated from the antenna device 110 is easy regardless of the orientation of the polarized wave to be transmitted.

As described above, the multiple radiating parts 20 may be arranged in a substantially spiral configuration. For example, the structure of the feed point 10c can be simplified. For example, the coaxial cable can be connected to the center of the radial waveguide; and the spirally-arranged multiple radiating parts 20 can be excited by a coaxial mode feeding.

As described above, the multiple radiating parts 20 may be provided in a substantially concentric circular configuration. For example, good radiation characteristics are obtained even for a small-scale antenna device in which the number of the multiple radiating parts 20 is small. For example, power is fed to the waveguide 10 in a rotational mode. The structure of the feed point 10c can be simplified by using the multiple radiating parts 20 in a concentric circular configuration. For example, because the symmetry of the arrangement of the multiple radiating parts 20 is good, good radiation characteristics are easily obtained even for a small-scale antenna device 110.

An electromagnetic wave is radiated (transmitted) from the antenna device 110 in the description above. According to the embodiment, the antenna device 110 may receive an electromagnetic wave. Even when an electromagnetic wave is received by the antenna device 110, for example, a tilted electromagnetic wave can be received with good characteristics.

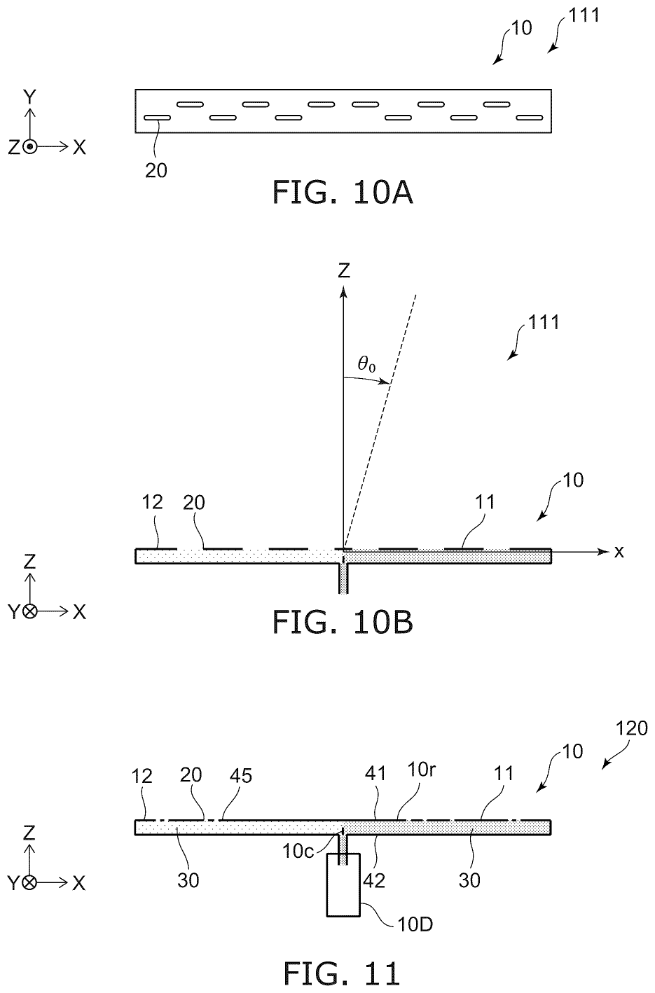

FIGS. 10A and 10B are schematic cross-sectional views illustrating an antenna device according to the first embodiment.

The waveguide 10 is a rectangular waveguide in the antenna device 111 according to the embodiment illustrated in FIG. 10A. In the antenna device 111, for example, the rectangular waveguide of the waveguide 10 may be formed by cutting metal. The rectangular waveguide of the waveguide 10 may be, for example, a substrate-integrated waveguide (SIW) formed using a dielectric substrate. In the antenna device 111, the multiple radiating parts 20 may be slots provided in the waveguide 10.

In the antenna device 111 as shown in FIG. 10B, the first waveguide wavelength λ1 in the waveguide in the first partial region 11 is less than the second waveguide wavelength 22 in the waveguide in the second partial region 12.

Thus, according to the embodiment, other than a radial waveguide, the waveguide 10 may be a rectangular waveguide. The waveguide 10 may be, for example, a ridge waveguide. The waveguide 10 may be, for example, a gap waveguide. The waveguide 10 may be, for example, a parallel-plate waveguide. The waveguide 10 may be, for example, a dielectric waveguide. According to the embodiment, in the various waveguides 10, for example, the slow-wave ratio ξ of the beam tilt direction is high (the guide wavelength is short), and the slow-wave ratio ξ in the direction opposite to the beam tilt direction is low (the guide wavelength is long). A beam tilt antenna in which grating lobes are suppressed is obtained thereby, without making the spacing of the multiple radiating parts 20 extremely narrow.

### Second Embodiment

FIG. 11 is a schematic cross-sectional view illustrating an antenna device according to a second embodiment.

As shown in FIG. 11, the antenna device 120 according to the embodiment includes a first driver 10D. Otherwise, the configuration of the antenna device 120 may be similar to the configuration of the antenna device (the antenna device 110, the antenna device 111, etc.) according to the first embodiment.

The first driver 10D is configured to rotate the waveguide 10 in a plane (the X-Y plane) including the first region 10r. The first electromagnetic wave 81 that is radiated from the multiple radiating parts 20 may be conically scanned by the rotation of the waveguide 10.

The first driver 10D mechanically (physically) rotates the waveguide 10. For example, the beam (the first electromagnetic wave 81) can be conically scanned. Unlike a phased array that electronically performs beam scanning, the beam scanning is possible without using circuit elements such as phase shifters, etc.

According to the second embodiment, the antenna device 120 may be utilized as a receiving device. For example, an electromagnetic wave arriving along the direction of the angle (θ₀, ϕ₀) can be received.

### Third Embodiment

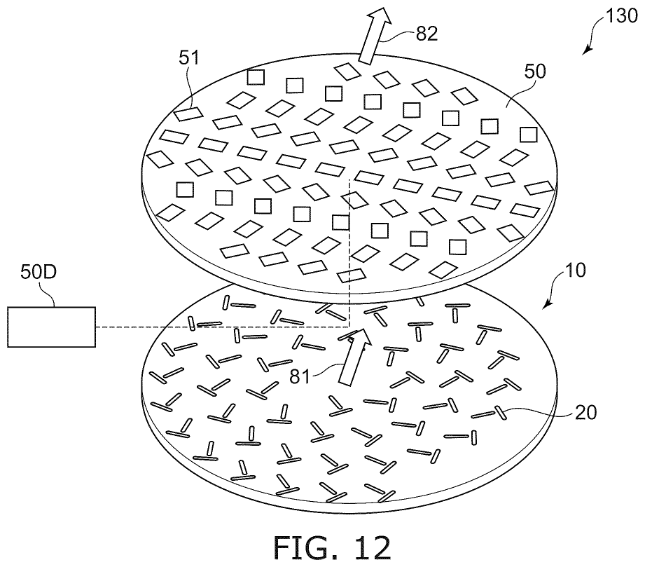

FIG. 12 is a schematic perspective view illustrating an antenna device according to a third embodiment.

As shown in FIG. 12, the antenna device 130 according to the embodiment further includes a transmissive member 50 in addition to the waveguide 10. Otherwise, the configuration of the antenna device 130 may be similar to the configurations of the antenna devices 110, 111, and 120.

In the antenna device 130, the transmissive member 50 is configured to transmit the first electromagnetic wave 81 radiated from the multiple radiating parts 20. The transmissive member 50 may be configured to change the transmission phase of the first electromagnetic wave 81. For example, the direction of a second electromagnetic wave 82 radiated from the transmissive member 50 changes according to the change of the transmission phase.

For example, the transmissive member 50 tilts the beam by changing the pass phase of the electromagnetic field of the first electromagnetic wave 81. The tilt angle of the beam due to the transmissive member 50 may be the same as or different from the tilt angle of the beam due to the waveguide 10.

In the example of FIG. 12, the transmissive member 50 includes multiple transmissive portions 51. In the example, the distribution of the multiple transmissive portions 51 is different within the plane.

As shown in FIG. 12, the antenna device 130 may further include a second driver 50D. The second driver 50D is configured to rotate the transmissive member 50. The direction of the second electromagnetic wave 82 changes according to the rotation of the transmissive member 50.

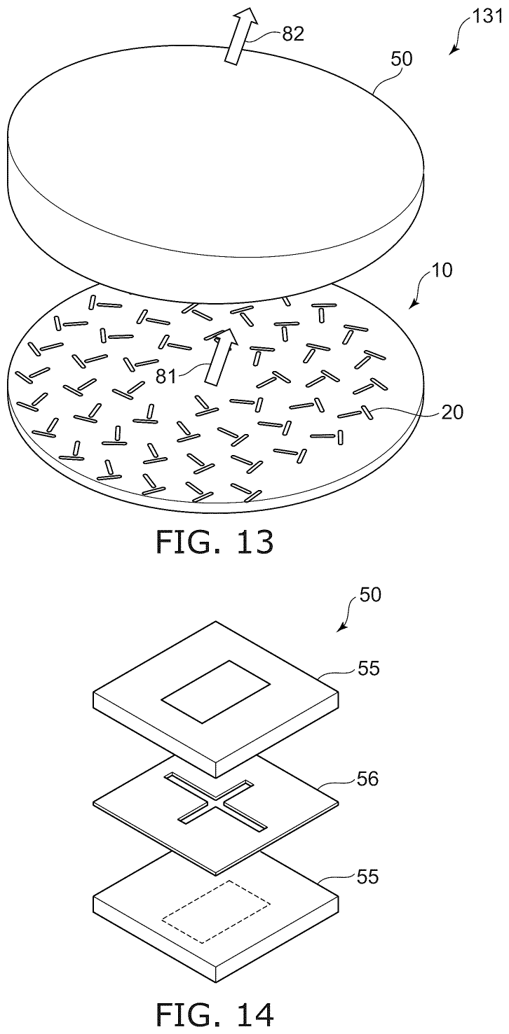

FIG. 13 is a schematic perspective view illustrating an antenna device according to the third embodiment.

As shown in FIG. 13, the antenna device 131 according to the embodiment also includes the transmissive member 50. In the antenna device 131, the thickness of the transmissive member 50 is different within the plane.

The transmissive member 50 may include a transmit-array. The transmit-array is, for example, an array of multiple elements (unit cells) having different pass phases.

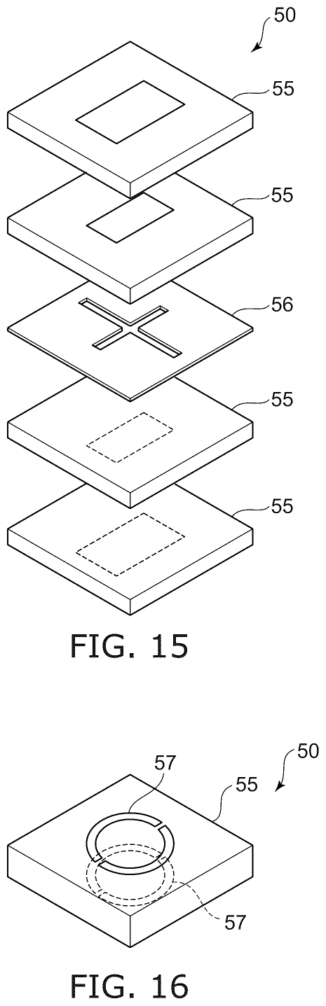

FIGS. 14 to 16 are schematic views illustrating portions of the antenna device according to the third embodiment. These drawings each illustrate one unit cell included in the transmit-array. In the example of FIG. 14, two dielectric substrates 55 including metal patches and a metal plate 56 including a cross-shaped slot are combined. The pass phase of the circularly polarized wave can be changed by changing the rotation angle of the unit cell.

In the example of FIG. 15, one unit cell is a combination of four dielectric substrates 55 including metal patches, and the metal plate 56 including the cross-shaped slot. For example, the unit cell can function in a wider frequency band by increasing the number of the dielectric substrates 55.

In the example of FIG. 16, split rings 57 are provided at respectively two surfaces of the dielectric substrate 55.

For example, the transmissive members 50 illustrated in FIGS. 14 to 15 may be rotated in the plane. For example, the pass phase of the circularly polarized wave can be changed. For example, the transmissive member 50 can tilt the beam by changing the pass phase of the electromagnetic wave. Various modifications of the configuration of the transmissive member 50 are possible.

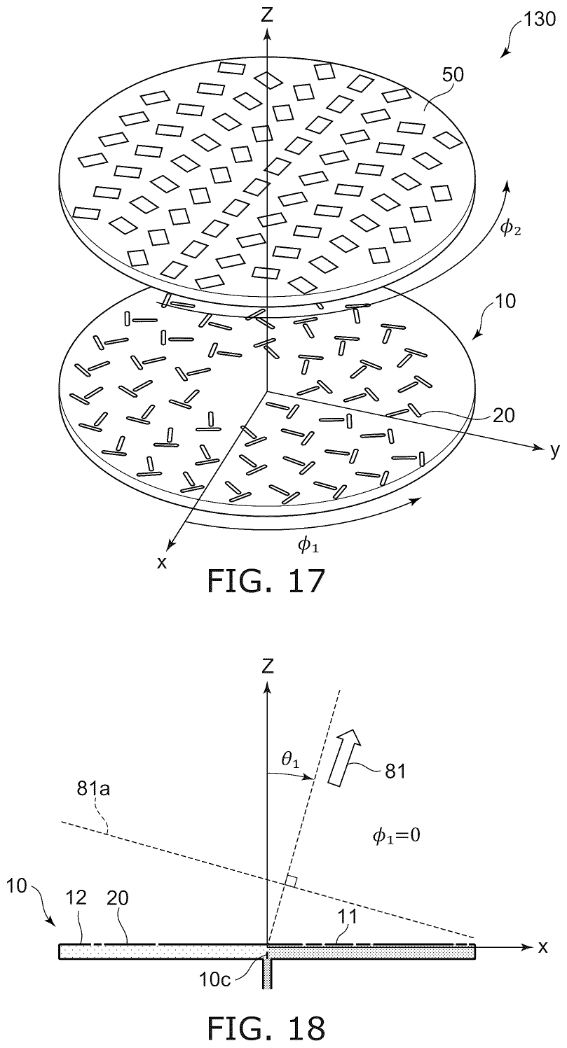

FIGS. 17 to 19 are schematic views illustrating the antenna device according to the third embodiment.

As shown in FIG. 17, the rotation angle of the waveguide 10 is taken as an angle ϕ₁. The rotation angle of the transmissive member 50 is taken as an angle ϕ₂.

As shown in FIG. 18, for example, when the angle ϕ₁ of the waveguide 10 is 0, the first electromagnetic wave 81 is radiated in the direction of an angle θ₁ from the waveguide 10. An equiphase surface 81a of the first electromagnetic wave 81 is formed. The equiphase surface 81a is perpendicular to the direction of the angle θ₁. The first electromagnetic wave 81 is radiated in the direction of the angle θ₁.

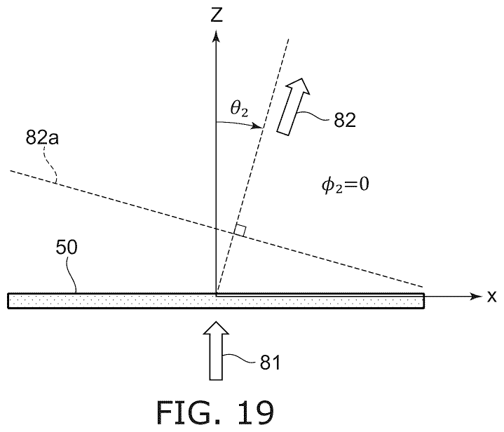

As shown in FIG. 19, a pass phase distribution 82a is formed in the transmissive member 50. For example, when the first electromagnetic wave 81 is irradiated toward the transmissive member 50, the transmissive member 50 radiates the second electromagnetic wave 82 to the direction of an angle θ₂.

The transmissive member 50 overlaps the waveguide 10. In this state, the waveguide 10 is rotated the angle ϕ₁, and the transmissive member 50 is rotated the angle ϕ₂. In such a case, the x-component “kₓ” and the y-component “k_{y}” of the wave number of the second electromagnetic wave 82 passing through the transmissive member 50 are represented by the following fifth formula.

$${k}_{x} = {k}_{0} [ sin {θ}_{1} cos {ϕ}_{1} + sin {θ}_{2} cos {ϕ}_{2} ] \qquad ( 5 )$$

$${k}_{y} = {k}_{0} [ sin {θ}_{1} sin {ϕ}_{1} + sin {θ}_{2} sin {ϕ}_{2} ]$$

In the fifth formula, a wave number k₀ is 2π/λ₀. λ₀ is the free-space wavelength.

The tilt direction (θ₀, ϕ₀) of the beam of the antenna device 120 from the fifth formula is represented by the following sixth formula and seventh formula.

$${θ}_{0} = {sin}^{- 1} \frac{\sqrt{{k}_{x}^{2} + {k}_{y}^{2}}}{{k}_{0}} \qquad ( 6 )$$

$${ϕ}_{0} = {tan}^{- 1} \frac{{k}_{y}}{{k}_{x}} \qquad ( 7 )$$

“kₓ” and “k_{y}” are changed by the angle ϕ₁ (the rotation angle) of the waveguide 10 and the angle ϕ₂ (the rotation angle) of the transmissive member 50. The tilt direction (θ₀, ϕ₀) of the beam can be changed by these angles.

For example, the waveguide 10 that has an angle θ₁ of not less than 30 degrees and the transmissive member 50 that has the angle θ₂ of not less than 30 degrees are combined. The angle ϕ₁ of the waveguide 10 and the angle ϕ₂ of the transmissive member 50 are changed (rotated) in the range of not less than −180 degrees and not more than 180 degrees. Accordingly, the angle θ₀ changes in the range of not less than 0 degrees and not more than 90 degrees, and the angle ϕ₀ changes in the range of not less than −180 degrees and not more than 180 degrees. The two-dimensional beam scanning is possible in any direction.

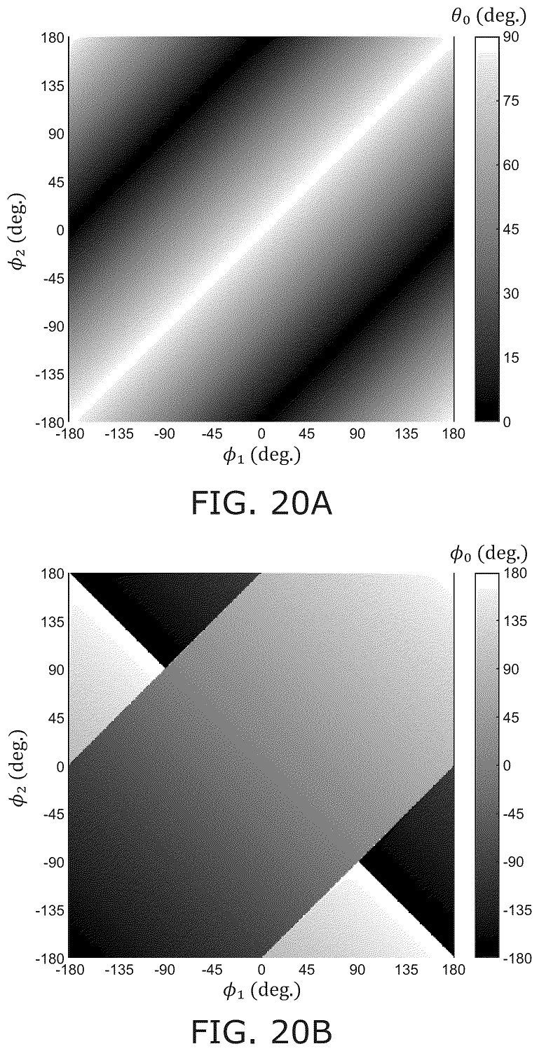

FIGS. 20A and 20B are schematic views illustrating characteristics of the antenna device according to the third embodiment.

These figures illustrate the tilt direction (θ₀, ϕ₀) of the beam when the waveguide 10 and the transmissive member 50 are rotated. In the example, the angle θ₁ and the angle θ₂ are 30 degrees. The angle ϕ₁ of the waveguide 10 and the angle ϕ₂ of the transmissive member 50 are changed in the range of not less than −180 degrees and not more than 180 degrees.

By changing the angle ϕ₁ and the angle ϕ₂ as shown in FIG. 20A, θ₀ changes in the range of not less than 0 degrees and not more than 90 degrees. For example, the angle θ₀ is 0 degrees when the angle ϕ₂ is ϕ₁±180 degrees. For example, the angle θ₀ is 90 degrees when the angle ϕ₂ is equal to the angle ϕ₁.

By changing the angle ϕ₁ and the angle ϕ₂ as shown in FIG. 20B, ϕ₀ changes in the range of not less than −180 degrees and not more than 180 degrees. For example, the angle ϕ₁ and the angle ϕ₂ are changed while maintaining a constant difference between the angle ϕ₁ and the angle θ₂. Accordingly, the angle do can be changed while maintaining a constant angle θ₀.

The transmissive member 50 may be included as described above. The direction of the first electromagnetic wave 81 radiated from the waveguide 10 can be changed by the transmissive member 50. For example, the range of the beam scanning can be increased. The transmissive member 50 may be mechanically rotated. The second driver 50D may perform the rotation. The range of the beam scanning can be further increased.

For example, two-dimensional beam scanning is made possible by the rotation of the waveguide 10 and the rotation of the transmissive member 50. For example, in a reference example in which beam scanning is performed electronically by a phased array, an additional circuit of phase shifters or the like is included. According to the embodiment, such an additional circuit is unnecessary. According to the embodiment, for example, beam scanning can be performed inexpensively.

The equiphase surface 81a illustrated in FIG. 18 is linear. According to the embodiment, the equiphase surface 81a may not be linear. The pass phase distribution 82a illustrated in FIG. 19 is linear. According to the embodiment, the pass phase distribution 82a may not be linear.

When the equiphase surface 81a is nonlinear, the pass phase distribution 82a may be changed to correct the equiphase surface 81a. When the pass phase distribution 82a is nonlinear, the equiphase surface 81a may be changed to correct the pass phase distribution 82a.

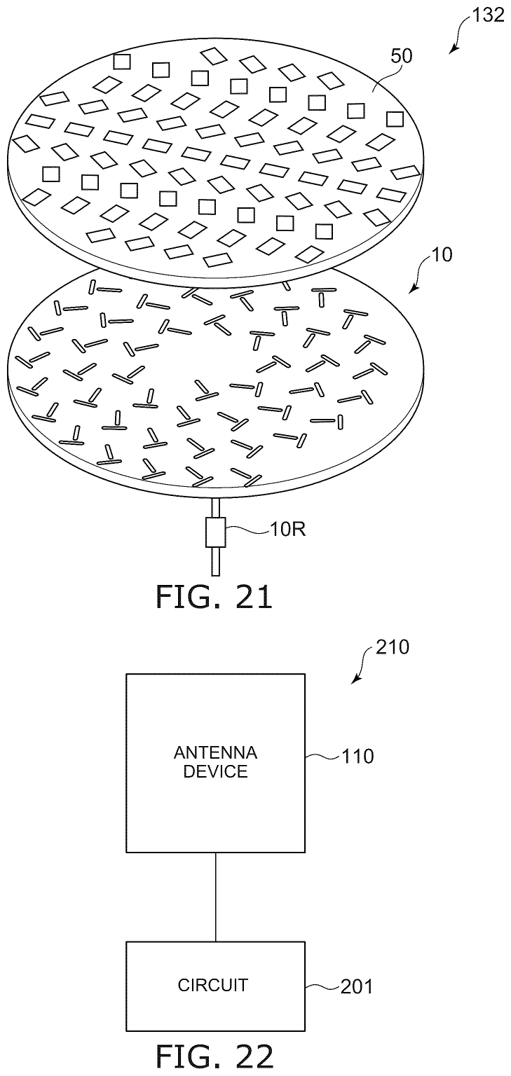

FIG. 21 is a schematic view illustrating an antenna device according to the third embodiment.

As shown in FIG. 21, the antenna device 132 according to the embodiment includes a rotary joint 10R in addition to the waveguide 10 and the transmissive member 50. Otherwise, the configuration of the antenna device 132 may be similar to the configuration of the antenna device 130.

In the antenna device 132, the rotary joint 10R is configured to hold the waveguide 10 and the transmissive member 50 at any angle. Accordingly, twisting and damage of the transmission line for power feeding is suppressed when the waveguide 10 and the transmissive member 50 are mechanically rotated.

According to the embodiment, the first driver 10D and the second driver 50D described above may include motors, etc.

According to the third embodiment, the antenna device (the antenna devices 130 to 132) may be utilized as a receiving device. For example, an electromagnetic wave that arrives along the direction of the angle (θ₀, ϕ₀) can be received.

### Fourth Embodiment

A fourth embodiment relates to a wireless device.

FIG. 22 is a schematic view illustrating the wireless device according to the fourth embodiment.

As shown in FIG. 22, the wireless device 210 according to the embodiment includes the electrical circuit 201 and the antenna device (e.g., the antenna device 110) according to the first to third embodiments. The electrical circuit 201 is couplable to the feed point 10c of the waveguide 10 included in the antenna device 110. The electrical circuit 201 may be electrically connected with the feed point 10c.

For example, by providing the electrical circuit 201, the antenna device 110 can be utilized as a wireless communication device, a radar, a wireless power supply device, etc.

For example, the electrical circuit 201 is configured to supply a high-frequency signal to the antenna device 110. The electrical circuit 201 causes the antenna device 110 to radiate an electromagnetic wave. When the antenna device 110 receives an electromagnetic wave, the electrical circuit 201 is configured to demodulate a high-frequency signal.

According to the embodiment, the antenna device (e.g., the antenna device 110) and the wireless device 210 are applicable to wireless power transmission, radar, a wireless communication device using a phased array, etc.

According to the embodiment, grating lobes can be suppressed in an array antenna having beam tilt. The design freedom can be increased.

Embodiments may include the following configurations (e.g., technological proposals).

### Configuration 1

An antenna device, comprising:
a waveguide,
the waveguide including a feed point, and a first region around the feed point,
the waveguide being configured to guide a high-frequency signal supplied to the feed point,
the waveguide including a plurality of radiating parts located in the first region,
the first region including a first partial region and a second partial region,
the feed point being between the first partial region and the second partial region,
a first waveguide wavelength in the waveguide in the first partial region being less than a second waveguide wavelength in the waveguide in the second partial region.

### Configuration 2

The antenna device according to Configuration 1, wherein
the plurality of radiating parts is configured to radiate a first electromagnetic wave corresponding to the high-frequency signal,
a projection direction onto the waveguide of a major radiation direction of the first electromagnetic wave is along a first direction, and
the first direction is from the second partial region toward the first partial region.

### Configuration 3

The antenna device according to Configuration 2, wherein
the waveguide includes a first member, and
a first slow-wave ratio of the first member in the first partial region is different from a second slow-wave ratio of the first member in the second partial region.

### Configuration 4

The antenna device according to Configuration 3, wherein
the first member includes a dielectric.

### Configuration 5

The antenna device according to Configuration 1 or 2, wherein
the waveguide includes a first member,
the first member includes:
   a first member region corresponding to the first partial region; and
   a second member region corresponding to the second partial region,
the first member region and the second member region satisfy at least one of a first condition, a second condition, a third condition, or a fourth condition,
in the first condition, a relative dielectric constant of the first member region is different from a relative dielectric constant of the second member region,
in the second condition, a density of a plurality of holes included in the first member region is different from a density of a plurality of holes included in the second member region,
in the third condition, an average size of the plurality of holes included in the first member region is different from an average size of the plurality of holes included in the second member region, and
in the fourth condition, a configuration of a structure body located in the first member region is different from a configuration of a structure body located in the second member region.

### Configuration 6

The antenna device according to any one of Configurations 1 to 5, wherein
the first waveguide wavelength is a wavelength of the high-frequency signal propagating along a direction from the feed point toward the first partial region, and
the second waveguide wavelength is a wavelength of the high-frequency signal propagating along a direction from the feed point toward the second partial region.

### Configuration 7

The antenna device according to Configuration 1, wherein
a spacing of the plurality of radiating parts in a radial direction is less than λ₀/(1+sin θ₀),
the radial direction passes through the feed point along the first region,
λ₀ is a wavelength of the high-frequency signal in free space, and
θ₀ is an angle between a direction perpendicular to the first region and a major radiation direction of a first electromagnetic wave radiated from the plurality of radiating parts.

### Configuration 8

The antenna device according to any one of Configurations 1 to 7, wherein
the first region includes a third partial region and a fourth partial region,
the feed point is between the third partial region and the fourth partial region,
a direction from the feed point toward the third partial region crosses a direction from the feed point toward the first partial region,
a third waveguide wavelength in the waveguide in the third partial region is greater than the first waveguide wavelength and less than the second waveguide wavelength, and
a fourth waveguide wavelength in the waveguide in the fourth partial region is greater than the first waveguide wavelength and less than the second waveguide wavelength.

### Configuration 9

The antenna device according to any one of Configurations 1 to 8, wherein
one of the plurality of radiating parts includes a slot pair.

### Configuration 10

The antenna device according to any one of Configurations 1 to 9, wherein
the plurality of radiating parts is configured to radiate a circularly polarized wave.

### Configuration 11

The antenna device according to any one of Configurations 1 to 10, wherein
the plurality of radiating parts is arranged in a substantially spiral configuration in the first region.

### Configuration 12

The antenna device according to any one of Configurations 1 to 10, wherein
the plurality of radiating parts is arranged in a substantially concentric circular configuration in the first region.

### Configuration 13

The antenna device according to Configuration 1, further comprising:
a first driver,
the first driver being configured to rotate the waveguide in a plane including the first region,
a first electromagnetic wave radiated from the plurality of radiating parts being conically scanned by a rotation of the waveguide.

### Configuration 14

The antenna device according to Configuration 1, further comprising:
a transmissive member,
the transmissive member being configured to transmit a first electromagnetic wave radiated from the plurality of radiating parts,
the transmissive member being configured to change a transmission phase of the first electromagnetic wave,
a direction of a second electromagnetic wave radiated from the transmissive member changing according to the change of the transmission phase.

### Configuration 15

The antenna device according to Configuration 14, further comprising:
a second driver,
the second driver being configured to rotate the transmissive member,
the direction of the second electromagnetic wave changing according to a rotation of the transmissive member.

### Configuration 16

An antenna device, comprising:
a waveguide,
the waveguide including a feed point, and a first region around the feed point,
the waveguide being configured to guide a high-frequency signal supplied to the feed point,
the waveguide including a plurality of radiating parts located in the first region,
the first region including a first partial region and a second partial region,
the feed point being between the first partial region and the second partial region,
the waveguide including a first member,
the first member including
   a first member region corresponding to the first partial region, and
   a second member region corresponding to the second partial region,
the first member region and the second member region satisfying at least one of a first condition, a second condition, a third condition, or a fourth condition,
in the first condition, a relative dielectric constant of the first member region being different from a relative dielectric constant of the second member region,
in the second condition, a density of a plurality of holes included in the first member region being different from a density of a plurality of holes included in the second member region,
in the third condition, an average size of the plurality of holes included in the first member region being different from an average size of the plurality of holes included in the second member region,
in the fourth condition, a configuration of a structure body located in the first member region being different from a configuration of a structure body located in the second member region.

### Configuration 17

A wireless device, comprising:
the antenna device according to Configuration 1; and
an electrical circuit couplable to the feed point.

According to embodiments, an antenna device and a wireless device can be provided in which the characteristics can be improved.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in antenna devices such as waveguides, transmissive members, drivers etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all antenna devices and wireless devices practicable by an appropriate design modification by one skilled in the art based on the antenna devices and the wireless devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An antenna device, comprising:
a waveguide,
the waveguide including a feed point, and a first region around the feed point,
the waveguide being configured to guide a high-frequency signal supplied to the feed point,
the waveguide including a plurality of radiating parts located in the first region,
the first region including a first partial region and a second partial region,
the feed point being between the first partial region and the second partial region,
a first waveguide wavelength in the waveguide in the first partial region being less than a second waveguide wavelength in the waveguide in the second partial region.

2. The antenna device according to claim 1, wherein
the plurality of radiating parts is configured to radiate a first electromagnetic wave corresponding to the high-frequency signal,
a projection direction onto the waveguide of a major radiation direction of the first electromagnetic wave is along a first direction, and
the first direction is from the second partial region toward the first partial region.

3. The antenna device according to claim 2, wherein
the waveguide includes a first member, and
a first slow-wave ratio of the first member in the first partial region is different from a second slow-wave ratio of the first member in the second partial region.

4. The antenna device according to claim 3, wherein
the first member includes a dielectric.

5. The antenna device according to claim 1, wherein
the waveguide includes a first member,
the first member includes:
a first member region corresponding to the first partial region; and
a second member region corresponding to the second partial region,
the first member region and the second member region satisfy at least one of a first condition, a second condition, a third condition, or a fourth condition,
in the first condition, a relative dielectric constant of the first member region is different from a relative dielectric constant of the second member region,
in the second condition, a density of a plurality of holes included in the first member region is different from a density of a plurality of holes included in the second member region,
in the third condition, an average size of the plurality of holes included in the first member region is different from an average size of the plurality of holes included in the second member region, and
in the fourth condition, a configuration of a structure body located in the first member region is different from a configuration of a structure body located in the second member region.

6. The antenna device according to claim 1, wherein
the first waveguide wavelength is a wavelength of the high-frequency signal propagating along a direction from the feed point toward the first partial region, and
the second waveguide wavelength is a wavelength of the high-frequency signal propagating along a direction from the feed point toward the second partial region.

7. The antenna device according to claim 1, wherein
a spacing of the plurality of radiating parts in a radial direction is less than λ₀/(1+sin θ₀),
the radial direction passes through the feed point along the first region,
λ₀ is a wavelength of the high-frequency signal in free space, and
θ₀ is an angle between a direction perpendicular to the first region and a major radiation direction of a first electromagnetic wave radiated from the plurality of radiating parts.

8. The antenna device according to claim 1, wherein
the first region includes a third partial region and a fourth partial region,
the feed point is between the third partial region and the fourth partial region,
a direction from the feed point toward the third partial region crosses a direction from the feed point toward the first partial region,
a third waveguide wavelength in the waveguide in the third partial region is greater than the first waveguide wavelength and less than the second waveguide wavelength, and
a fourth waveguide wavelength in the waveguide in the fourth partial region is greater than the first waveguide wavelength and less than the second waveguide wavelength.

9. The antenna device according to claim 1, wherein
one of the plurality of radiating parts includes a slot pair.

10. The antenna device according to claim 1, wherein
the plurality of radiating parts is configured to radiate a circularly polarized wave.

11. The antenna device according to claim 1, wherein
the plurality of radiating parts is arranged in a substantially spiral configuration in the first region.

12. The antenna device according to claim 1, wherein
the plurality of radiating parts is arranged in a substantially concentric circular configuration in the first region.

13. The antenna device according to claim 1, further comprising:
a first driver,
the first driver being configured to rotate the waveguide in a plane including the first region,
a first electromagnetic wave radiated from the plurality of radiating parts being conically scanned by a rotation of the waveguide.

14. The antenna device according to claim 1, further comprising:
a transmissive member,
the transmissive member being configured to transmit a first electromagnetic wave radiated from the plurality of radiating parts,
the transmissive member being configured to change a transmission phase of the first electromagnetic wave,
a direction of a second electromagnetic wave radiated from the transmissive member changing according to the change of the transmission phase.

15. The antenna device according to claim 14, further comprising:
a second driver,
the second driver being configured to rotate the transmissive member,
the direction of the second electromagnetic wave changing according to a rotation of the transmissive member.

16. An antenna device, comprising:
a waveguide,
the waveguide including a feed point, and a first region around the feed point,
the waveguide being configured to guide a high-frequency signal supplied to the feed point,
the waveguide including a plurality of radiating parts located in the first region,
the first region including a first partial region and a second partial region,
the feed point being between the first partial region and the second partial region,
the waveguide including a first member,
the first member including
a first member region corresponding to the first partial region, and
a second member region corresponding to the second partial region,
the first member region and the second member region satisfying at least one of a first condition, a second condition, a third condition, or a fourth condition,
in the first condition, a relative dielectric constant of the first member region being different from a relative dielectric constant of the second member region,
in the second condition, a density of a plurality of holes included in the first member region being different from a density of a plurality of holes included in the second member region,
in the third condition, an average size of the plurality of holes included in the first member region being different from an average size of the plurality of holes included in the second member region,
in the fourth condition, a configuration of a structure body located in the first member region being different from a configuration of a structure body located in the second member region.

17. A wireless device, comprising:
the antenna device according to claim 1; and
an electrical circuit couplable to the feed point.
